(19) United States
(12) Patent Application Publication
(10) Pub. No.: US 2025/0259618 A1
(43) Pub. Date: Aug. 14, 2025

(54) SYSTEM AND METHOD FOR AUGMENTING CHANNEL CHARACTERISTICS OF AUDIO RECORDINGS

(71) Applicant: Gnani Innovations Private Limited, Bengaluru (IN)

(72) Inventors: Shreya Chaturvedi, Ahmedabad (IN); Thoshith S, Bangalore (IN); Bharath Shankar, Bangalore (IN)

(21) Appl. No.: 18/797,611

(22) Filed: Aug. 8, 2024

(30) Foreign Application Priority Data
Feb. 14, 2024 (IN) 202441010329

(51) Int. Cl. G10L 13/02; G10L 25/18

(52) U.S. Cl. CPC G10L 13/02; G10L 25/18

(57) ABSTRACT

The present disclosure provides a system (110) and a method (400) for augmenting channel characteristics of audio recordings. The system (110) receives a parallel corpus comprising a first set of audio recordings having a source channel characteristic and a second set of audio recordings having a target channel characteristic. The system (110) converts the parallel corpus into frequency domain features, extracts a channel impulse response based on the frequency domain features of the first and the second sets of audio recordings, and augments channel characteristics of an inference audio recording using the channel impulse response extracted from the parallel corpus.

### CROSS REFERENCE TO RELATED APPLICATIONS

The present application claims the benefit of Indian patent application Ser. No. 20/244,1010329 filed on Feb. 14, 2024, the contents of which are incorporated herein by reference in their entirety.

### TECHNICAL FIELD

The present disclosure relates to the field of speech processing. In particular, the present disclosure provides a system and a method for augmenting channel characteristics of audio recordings.

### BACKGROUND

Artificial Intelligence (AI) has many applications in cellular communication/telecommunication, among other fields. Various aspects of cellular customer services which have been automated, such as call management, traffic forecasting and optimized allocation of resources, speech analysis, improved customer service, optimized data compression and transmission, and the like. Such an enormous number of use-cases of AI can allow industries to save nearly $100 billion on telephonic centre services by 2027.

However, despite rapid development, an application where AI has struggled to provide performance with acceptable reliability is in speech processing of low-resource audio recordings, such as transcription or speech-to-text applications on telephonic conversations. Low-resource audio recordings are audio recordings with channel characteristics that are unavailable in training datasets with sizes that are sufficient to train AI models to perform with acceptable reliability. Low-resource audio recordings typically have noise and interference that provide them with unique channel characteristics. Examples of noise and interference include background noise, noise from other speakers/crosstalk, improper frequency (de)modulation, low channel quality, and channel noise. The noise and interference distort the audio recording, thereby making it difficult for existing models to transcribe text therefrom. Given performance of AI models is dependent on the amount and quality of training datasets, the lack of such datasets for low-resource audio recordings increases the difficulty of training models specifically for transcribing telephonic conversations/noisy audio recordings.

To alleviate this problem, some solutions include manually annotating noisy telephonic conversations, which are often difficult, time-consuming, and impractically expensive. Other solutions to improve the accuracy of speech recognition systems are to augment the low-resource audio data, such as cellular audio data, with synthetic data for training. Synthetic data is generated using additive computer algorithms which artificially add noise and reverberation on an ideal corpus (or a corpus with ideal audio quality). This synthetic data can be used to simulate a variety of real-world conditions, such as noise, interference, and different speaker accents and dialects. By augmenting the cellular audio data with synthetic data, speech recognition systems can be trained on a wider range of conditions and become more robust to noise and interference, which can improve accuracy of speech recognition systems on cellular audio devices. Solutions like the transformer-based “Jasper” model have shown improvements in accuracy in transcribing cellular audio datasets. However, such solutions do not provide flexibility to augment audio datasets having unique channel characteristics, such as between channel characteristics of a clean audio recording and telephonic audio recordings typically including unique audio characteristics due to compression technique, channel loss, encoding, decoding, etc.

Other solutions include the use of complicated AI models/architectures that process the audio recordings, and account for noise and interference typically seen in cellular audio recording. However, such solutions are often computationally expensive, and cannot be run on most Central Processing Units (CPUs), thereby limiting the scope of their application on most inexpensive computing devices, or in edge computing devices.

Existing solutions primarily focus on either building novel AI models/architectures or augmenting existing data. However, there is still a lack of solutions that augment or create audio datasets to train models capable of processing any audio recording having a distinct channel characteristic. Therefore, there is a need for a system and a method for augmenting channel characteristics of audio recordings.

### OBJECTS OF THE PRESENT DISCLOSURE

A general object of the present disclosure is to provide a system and a method for augmenting channel characteristics of audio recordings. An object of the present disclosure is to augment audio recordings

having source channel characteristics to any target channel characteristics for training machine learning models therewith.

Another object of the present disclosure is to minimize time and cost resources required for creating augmented audio datasets.

Yet another object of the present disclosure is to augment channel characteristics of audio recordings to allow machine learning models trained therewith to process audio recordings independent of language, device of recording, speaker, gender, sampling rate, length of the audio and audio formats.

### SUMMARY

The present disclosure relates to the field of speech processing. In particular, the present disclosure provides a system and a method for augmenting channel characteristics of audio recordings.

An aspect of the present disclosure pertains to a system for augmenting channel characteristics of audio recordings. The system is configured to receive a parallel corpus that includes a first set of audio recordings having a source channel characteristic and a second set of audio recordings having a target channel characteristic. The second set of audio recordings may be a function of the first set of audio recordings. The system is configured to convert the parallel corpus into frequency domain features, extract a channel impulse response based on the frequency domain features of the first and the second sets of audio recordings, and augment channel characteristics of an inference audio recording having the source channel characteristics to have the target channel characteristics using the channel impulse response extracted from the parallel corpus.

In some embodiments, to extract the channel impulse response, the system may be configured to determine a cross-correlation value between the frequency domain features of the first and the second sets of the audio recordings. The system may be configured to align the first and the second sets of the audio recordings with respect to time domain features thereof based on the cross-correlation value, and determine the channel impulse response from the frequency domain features of the aligned first and second sets of audio recordings.

In some embodiments, to determine the cross-correlation value the system may be configured to determine the minimum of cross-conjugate values of arguments of maxima of the frequency domain features of the first and the second sets of audio recordings.

In some embodiments, to determine the channel impulse response from the frequency domain features of the aligned first and second sets of audio recordings the system may be configured to deconvolve the second set of audio recordings using the first set of audio recording to obtain the channel impulse response.

In some embodiments, the channel impulse response may include one or more latent channel characteristics associated with the first and second sets of audio recordings.

In another aspect, a method for generating synthetic audio recording datasets includes receiving, by one or more processors, a parallel corpus may include a first set of audio recordings having a source channel characteristic and a second set of audio recordings having a target channel characteristic. The second set of audio recordings may be a function of the first set of audio recordings. The method includes converting, by the one or more processors, the parallel corpus into frequency domain features. The method also includes extracting, by the one or more processors, a channel impulse response based on the frequency domain features of the first and the second sets of audio recordings. The method further includes augmenting, by the one or more processors, channel characteristics of an inference audio recording using the channel impulse response extracted from the parallel corpus.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an example architectural representation of a system for augmenting channel characteristics of audio recordings, according to embodiments of the present disclosure.

FIG. 2 illustrates an example block diagram of the system, according to embodiments of the present disclosure.

FIG. 3 illustrates an example representation of operations performed by the system, according to embodiments of the present disclosure.

FIG. 4 illustrates an example flow diagram for a method for augmenting channel characteristics of audio recordings, according to embodiments of the present disclosure.

FIG. 5 illustrates an example computer system in which or with which embodiments of the system may be implemented, according to embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

Embodiments explained herein relate to the field of speech processing. In particular, the present disclosure provides a system and a method for augmenting channel characteristics of audio recordings.

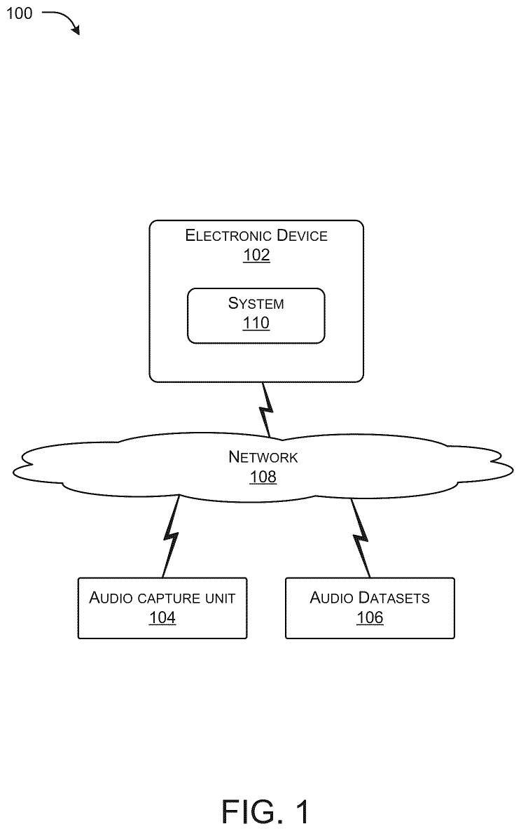

Various embodiments of the present disclosure will be explained in detail with reference to FIGS. 1-5.

Referring to FIG. 1, an example architectural representation 100 of a system 110 for augmenting channel characteristics of audio recordings is illustrated. As shown, the architecture 100 may include the system 110, an audio capture unit 104, and an audio dataset 106. In some embodiments, the system 110 may be implemented in an electronic device 102. In some embodiments, the system 110, the audio capture unit 104 and the audio dataset may be in communication via a network 108.

In an embodiment, the system 110 may be implemented by way of a single device or a combination of multiple devices that may be operatively connected or networked together. For example, the system 110 may be implemented by way of a standalone device such as a centralized server, and the like, and may be communicatively coupled to the electronic device 102. In another example, the system 110 may be implemented in/associated with the electronic device 102. In yet another example, the system 110 may be implemented in/associated with respective one or more computing devices of one or more corresponding users. In such a scenario, the system 110 may be replicated in each of the computing devices.

In some embodiments, the electronic device 102 may be at least one of an electrical, an electronic, an electromechanical, and a computing device. The electronic device 102 may be implemented in any one of, without limitation, a mobile device, a smart-phone, a Personal Digital Assistant (PDA), a tablet computer, a phablet computer, a wearable computing device, a Virtual Reality/Augmented Reality (VR/AR) device, a laptop, a desktop, a server, and the like.

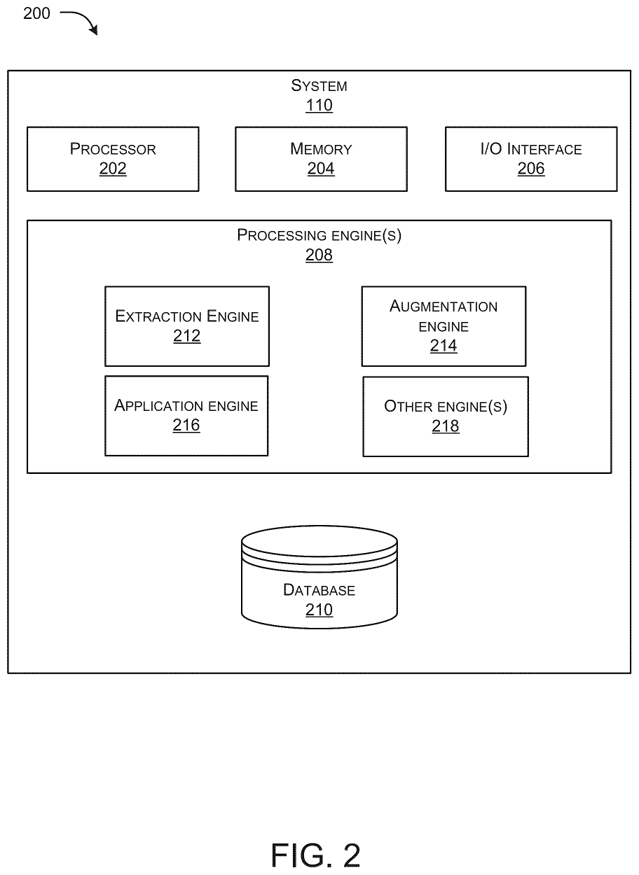

In some embodiments, the system 110 may be implemented in a hardware, or a suitable combination of hardware and software. Further, the system 110 may include one or more processors 202, Input/Output (I/O) interface(s) 206, and a memory 204, as illustrated and described in reference to FIG. 2. Further, the system 110 may also include other units such as a display unit, an input unit, an output unit, and the like, however the same are not shown in FIG. 1 or FIG. 2, for the purpose of clarity. Also, in FIG. 1, only a few units are shown, however, the system 110/architecture 100 may include any such numbers of the units as required to implement the features of the present disclosure.

In some embodiments, the system 110 may be a hardware device including the processors 202. The processors 202 may be configured to execute machine-readable program instructions. Execution of the machine-readable program instructions by the processors 202 may enable the proposed system 110 to augment audio datasets, which may be used for training machine learning models for processing audio recordings with unique channel characteristics. The “hardware” may include a combination of discrete components, an integrated circuit, an application-specific integrated circuit, a field programmable gate array, a digital signal processor, or other suitable hardware. The “software” may include one or more objects, agents, threads, lines of code, subroutines, separate software applications, two or more lines of code, or other suitable software structures operating in one or more software applications or on one or more processors.

In some embodiments, the network 108 may be a wired or a wireless communication means. In some embodiments, wired communication means may include, but not be limited to, electrical wires/cables, optical fibre cables, telephony, and the like. In some embodiments, the wireless communication means may be any wireless communication network capable of transferring data using means including, but not limited to, radio communication, satellite communication, a Bluetooth, a Zigbee, a Near Field Communication (NFC), a Wireless-Fidelity (Wi-Fi) network, a Light Fidelity (Li-Fi) network, a carrier network including a circuit-switched network, a packet switched network, a Public Switched Telephone Network (PSTN), a Content Delivery Network (CDN) network, an Internet, intranets, Local Area Networks (LANs), Wide Area Networks (WANs), mobile communication networks including a Second Generation (2G), a Third Generation (3G), a Fourth Generation (4G), a Fifth Generation (5G), a Sixth Generation (6G), a Long-Term Evolution (LTE) network, a New Radio (NR), a Narrow-Band (NB), an Internet of Things (IoT) network, a Global System for Mobile Communications (GSM) network and a Universal Mobile Telecommunications System (UMTS) network, combinations thereof, and the like.

In some embodiments, the audio capture unit 104 may be configured to capture audio recordings. In some embodiments, the audio capture unit 104 may include microphones specifically adapted for devices including, but not limited to, smartphones, laptops, desktops, mobile phones, tablets, phablets, video recording devices, standalone microphone devices, and the like. The specifications and capabilities of the microphone may differ based on the hardware employed for its construction. In some embodiments, the audio capture unit 104 may be a standalone audio recording device. In other embodiments, the audio capture unit 104 may be integrated with the system 110, or the electronic device 102 in which the system 110 is implemented.

In some embodiments, the audio capture unit 104 may be configured to transmit the audio recordings to the system 110 through one or more channels. In some embodiments, the channels may be indicative of wired and/or wireless communication means employed by the network 108. The channels may subject the audio recording to noise and interference, which may cause distortions in the audio recordings. In some embodiments, the noise and interference may include, but not be limited to, background noise, noise from other speakers/cross-talk, improper frequency (de)modulation, low channel quality, channel noise, (de)compression, and the like. In some embodiments, the noise may be either additive, or convolutive, or both. Noise and interference, and the specifications of the audio capture unit 104, may provide the audio recording with unique channel characteristics. In some embodiments, such channel characteristics of the audio recordings may be unique due to the nature of the channels/medium through which the audio recordings are transmitted, stored, and/or processed.

In some embodiments, the audio dataset 106 may be indicative of a dataset of audio recordings, where a first set of audio recordings may have a source channel characteristic, and a second set of audio recordings may have a target channel characteristic. In some embodiments, the audio dataset 106 may be a database storing the dataset of audio recordings. In some embodiments, the audio dataset 106 may indicative of existing, publicly available or privately curated, datasets. In some examples, the first set of audio recordings may be indicative of direct audio recordings recorded using the audio capture unit 104, and the second set of audio recordings may be indicative of the same audio recording transmitted through a channel (such as through wireless communication means), but not limited thereto. The audio dataset 106 may maintain a parallel corpus of the first and the second sets of audio recordings having different channel characteristics. The audio dataset 106 may be indicative of low-resource audio recordings. The system 110 may be configured to convert/augment channel characteristics of a set of inference audio recordings such that the inference audio recordings may be used for, among other applications, generating synthetic datasets for training machine learning models. In some embodiments, the inference audio recordings may have the source channel characteristics.

In an aspect, the system 110 may be configured to augment channel characteristics of the audio datasets 106. In some implementations, the system 110 may augment the audio recordings with the source channel characteristic to have the target channel characteristic, thereby making it suitable to train machine learning models that process audio recordings with the target channel characteristics. In such implementations, lack of sufficiently sizeable datasets of audio recordings with the target channel characteristics may present a significant technical challenge for training machine learning models. The system 110 may augment existing datasets of audio recordings having the source channel characteristics such that after said augmentation, the audio recordings have the target channel characteristics. In some examples, if the existing dataset had labels indicative of transcriptions of the audio recording, a machine leaning model may be trained by inputting the augmented audio recordings (now having the target channel characteristics) as input features and the transcriptions as labels. By augmenting inference audio recordings, such as existing datasets of audio recordings in some non-limiting examples, with the source channel characteristics such that they have the target channel characteristics, the system 110 may allow machine learning models to be trained to process audio recordings with the target channel characteristics. However, applications/implementations of the system 110 may not be limited thereto, and may also be used for, without limitation, real-time conversion of channel characteristics during audio streaming, enhancing quality of audio recordings, modifying nature of recording (such as for voice changing or voice enhancing applications in music), and the like.

In some embodiments, the system 110 may be configured to receive/retrieve a parallel corpus having the first set of audio recordings with the source channel characteristic and the second set of audio recordings with the target channel characteristic. In some embodiments, the second set of audio recordings may be defined as a function of the first set of audio recordings. The function may be indicative of an addition or a convolution of noise and interferences, and transformations performed on the first set of audio recordings when it passed through the channel such that they are transformed into the second set of audio recordings with the target channel characteristics. In some examples, the second set of audio recordings with the target channel characteristics (represented by y(n)) may be given by a convolution of the first set of audio recordings with the source channel characteristics (represented by x(n)) and a channel impulse response (represented by (H(Ω)). In such examples, the channel impulse response (also referred to as channel characteristics or latent channel characteristics) may represent time delays, attenuations, and distortions introduced by the channel used to transmit the first set of audio recordings. The first and the second set of audio recordings may have the same audio information, such as words spoken by a person for example, but may have different channel characteristics. In such examples, the first set of audio recordings being speech of a person recorded on a microphone and the second set of audio recording being the same recording of speech transmitted through a wired or wireless channel.

In some embodiments, the system 110 may be configured to preprocess the parallel corpus. In some embodiments, the system 110 may be configured to preprocess the parallel corpus by any one or combination of preprocessing means including, but not limited to, normalizing, checking whether the audio recording is clipped, resampling, filtering, feature extraction, and the like. In some embodiments, the system 110 may be configured to generate (mel)spectrograms of the audio recordings, to allow the audio recordings to be processed by machine learning models.

In some embodiments, the system 110 may be configured to convert the parallel corpus into frequency domain features. In some embodiments, the system 110 may convert both the first set of audio recordings and the second set of audio recordings in the parallel corpus into frequency domain features. In some embodiments, the system 110 may use any one or combination of including, but not limited to, Fourier Transform, Fast Fourier Transform, Discrete Fourier Transform, and the like, for converting the parallel corpus into frequency domain features. The frequency domain features, or frequency domain representations of the audio recordings in the parallel corpus, may indicate the distribution of different frequency bands over a range of frequencies. The frequency domain features may include phase information associated with the first and the second sets of audio recordings. The phase information therein may be used for determining misalignments between the first and the second sets of audio recordings.

In some embodiments, the system 110 may be configured to extract the channel impulse response associated with the parallel corpus, i.e. between the first set of audio recordings and the second set of audio recordings. In some embodiments, the system 110 may be configured to determine a cross-correlation value between frequency domain features of the first and the second sets of the audio recordings. In some embodiments, the system 110 may be configured to determine a cross-correlation value between the first and second sets of audio recordings. The system 110 may be configured to compare the frequency domain features of the first and second sets of audio recordings to determine the cross-correlations value. The cross-correlation value may indicate any time shifts between the first and the second audio recordings. In some embodiments, the cross-correlation value may be determined as the minimum of cross-conjugate values of arguments of maxima of the frequency domain features of the first and the second sets of audio recordings.

In some embodiments, the system 110 may be configured to align the first and the second sets of the audio recordings with respect to time domain features thereof based on the correlation value. In such embodiments, the system 110 may resolve any temporal differences between the first and the second sets of audio recordings. In such embodiments, the system 110 may resolve any misalignments with respect to the time domain or time/phase shift between the first and the second set of audio recordings, which may be caused due to code switching, specifications of the channel, time delays in transmission and receipt of audio signals, latency, and the like. By eliminating the misalignments, the system 110 may be prevented from mapping acoustic manual vibrations, among other features, as channel characteristics, thereby improving accuracy of channel characteristics extracted from the first and the second sets of audio recordings.

In some embodiments, the system 110 may be configured to extract the channel impulse response based on the frequency domain features of the first and the second sets of audio recordings. In some embodiments, the system 110 may determine the channel impulse response based on the frequency domain features of the aligned first and second sets of audio recordings. In such embodiments, the system 110 may be configured to deconvolve the second set of audio recordings using the first set of audio recordings to obtain the channel impulse response. In some examples, the frequency domain features of the second set of recordings may be divided by the frequency domain features of the first set of audio recordings to obtain the channel impulse response. The channel impulse response, in such examples, may be represented by a mathematical operation/function.

In some embodiments, the channel impulse response extracted from the first and the second sets of audio recordings may be latent. In some examples, the channel impulse response may be configured to be represented by a square matrix having fixed dimensions that are smaller than those of the audio recordings. By allowing the channel impulse response to be indicative of latent channel characteristics, the system 110 may be able to augment audio recordings of any length to have the target channel characteristics.

In some embodiments, the system 110 may be configured to receive the inference audio recording. In some embodiments, the inference audio recording may be indicative of audio recordings, or datasets thereof, which may be augmented for allowing a machine learning model to be trained therewith such that they learn to process audio recordings having the target channel characteristics. The inference audio recording may have the source channel characteristics, and the system 110 may be configured augment them such that the augmented inference audio recording has target channel characteristics. In some embodiments, the inference audio recordings may be received from the audio capture unit 104. In such embodiments, the system 110 may be configured to perform real-time augmentation for of the inference audio recording for applications where the machine learning model process the augmented inference audio recording in real-time. In other embodiments, the inference audio recordings may be indicative of a public or privately curated dataset of audio recordings having the source channel characteristics, which may be used to train the machine learning model after augmentation. In some embodiments, the machine learning model may be any one or combination of including, but not limited to, decision trees, random forest trees, support vector machines, multi-layer perceptrons, hidden Markov models, artificial neural networks, convolutional neural networks, recurrent neural networks, transformers, and the like. The machine learning model may be implemented on a hardware device, or emulated on a computing device. In some embodiments, the system 110 may be configured to preprocess the inference audio recording using any one or combination of the preprocessing means.

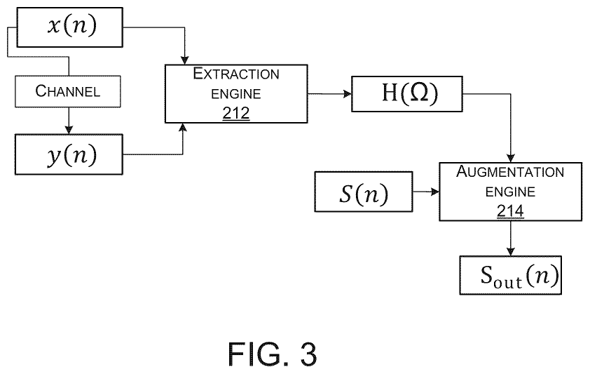

In some embodiments, the system 110 may be configured to augment the inference audio recordings using the channel impulse response extracted from the parallel corpus (i.e. the first and the second sets of audio recordings). In some embodiments, the system 110 may be configured to apply the extracted channel impulse response (represented by H(Ω)) to the inference audio recordings (represented by S(n)) such that they are augmented to have the target channel characteristics (the augmented inference audio recording being represented by Sₒᵤₜ(n), as shown in FIG. 3).

In some embodiments, the system 110 may be configured to provide the augmented inference audio recordings to the machine learning model as input. The machine learning model may be configured to process the inference audio recording to generate an output. In other embodiments, the system 110 may be configured to augment existing audio datasets to have the target channel characteristics, such that they can be used for training machine learning models to learn to process audio recordings having the target channel characteristics. In some embodiments, the machine learning model may be configured to perform tasks including, but not limited to, transcription, translation, speaker recognition, voice modulation/augmentation, audio synthesis, audio analysis, and the like.

Once the channel impulse response has been extracted from the parallel corpus, the system 110 may use existing audio datasets or the inference audio recordings indicative of datasets having (source) channel characteristic to be converted into any desired (target) channel characteristic using the channel impulse response. In such embodiments, the system 110 may have an increased number of datasets to train machine learning models for processing audio recordings having the desired (target) channel characteristic. In some examples, the system 110 may be used to augment of audio recordings indicative of studio recordings (having human annotated transcriptions) to have channel characteristics of a cellular audio recordings. In such examples, the system 110 may use the augmented studio recordings datasets to train machine learning models therewith and the corresponding human-annotated transcriptions such that the machine learning models learn to transcribe cellular audio recordings. Since sizes of studio recording datasets may be larger than those for cellular audio recordings, augmentation of the studio recording datasets may allow machine learning models to be trained with larger amounts of data, and thereby have acceptably reliable performance in processing cellular audio recordings.

The augmented audio recording, and the datasets built therewith, may also minimize time and cost resource required for creating augmented audio datasets. For instance, by extracting differences in channel characteristics between the first and the second sets of audio recordings and applying the differences to the audio dataset 106, the system 110 may augment the audio dataset 106 using reversible transformations that may be performed using Central Processing Units (CPUs), and without necessitating the need for expensive channel emulation infrastructure. Further, since the source and the target channel characteristics may be distinct (and representative of any two audio recordings), the system 110 may be able to augment channel characteristics of the audio datasets 106 to allow the machine learning models trained therewith to process audio recordings independent of language, device of recording, speaker, gender, sampling rate, length of the audio and audio formats, thereby providing enhance flexibility to users.

Referring to FIG. 2, the system 110 may include one or more processor(s) 202, as illustrated in block diagram 200. The one or more processor(s) 202 may be implemented as one or more of including, but not limited to, microprocessors, microcomputers, microcontrollers, digital signal processors, central processing units, state machines, logic circuits, and any devices that manipulate data or signals based on operational instructions, and the like. Among other capabilities, the processor 202 may fetch and execute processor-readable/processor-executable instructions in the memory 204 operationally coupled with the system 110 for performing tasks such as data processing, input/output processing, feature extraction, and/or any other functions. Any reference to a task in the present disclosure may refer to an operation being or that may be performed on data. The memory 204 may store one or more machine-readable/processor-executable instructions or routines, which may be fetched and executed to create or share the data units over a network service. In some embodiments, the memory 204 may include any non-transitory storage device including, for example, volatile memory such as Random Access Memory (RAM), or non-volatile memory such as an Erasable Programmable Read-Only Memory (EPROM), flash memory, and the like.

In an embodiment, the system 110 may also include input/output (I/O) interface(s) 206. The interface(s) 206 may include a variety of interfaces, for example, interfaces for data input and output devices, referred to as I/O devices, storage devices, and the like. The interface(s) 206 may facilitate communication between the system 110, the audio capture unit 104, and the audio dataset 106. The interface(s) 206 may also provide a communication pathway for one or more components of the system 110. Examples of such components include, but are not limited to, processing engine(s) 208 and database 210.

In an embodiment, the processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may include a processing resource (for example, one or more processors), to execute such instructions.

In other embodiments, the processing engine(s) 208 may be implemented by electronic circuitry. The database 210 may include data that is either stored or generated as a result of functionalities implemented by any of the components of the processing engine(s) 208. In some embodiments, the database 210 may also store the weights associated with the machine learning model.

In some embodiments, the processing engine(s) 208 may include an extraction engine 212, an augmentation engine 214, an application engine 216, and other engine(s) 218. The other engine(s) 218 may implement functionalities that supplement applications/functions performed by the controller 110.

In some embodiments, the extraction engine 212 may be configured receive the parallel corpus having the first and the second sets of audio recordings, and extract the channel impulse response therefrom.

In some embodiments, the augmentation engine 214 may be configured to receive the inference audio recordings, and generate the augmented inference audio recordings using the channel impulse response extracted by the extraction engine 212.

In some embodiments, the application engine 216 may be configured to use the augmented inference audio recordings for performance of a predefined task. In some embodiments, the application engine 216 may use the augmented inference audio recordings for training a machine learning model. In other embodiments, the application engine 216 may be use the augmented inference audio recordings for real-time applications, as described above.

Referring to FIG. 3, an example representation of operation performed by the system 110 is illustrated.

As shown, the first set of audio recordings may be represented by x(n). In such embodiments, the x(n) may be indicative of time domain features/representation of the first set of audio recordings. The second set of audio recordings, represented by y(n), may be generated by passing the first set of audio recordings through a channel, such as telephony, radio, or satellite, for example, but not limited thereto. In such embodiments, y(n) may be indicative of time domain features/representations of the second set of audio recordings. The extraction engine 212 may be configured to receive both the first and the second set of audio recordings, and extract the channel impulse response (represented by H(Ω)) therefrom. In some embodiments, the extraction engine 212 may be configured to perform preprocessing on the first and the second set of audio recordings, such as alignment thereof, before extracting the channel impulse response.

Once the channel impulse response is extracted, the augmentation engine 214 may receive the inference audio recordings (represented by S(n)), and use the extracted channel impulse response to obtain the augmented inference audio recordings (represented by Sₒᵤₜ(n)). The augmented inference audio recordings may be indicative of audio datasets, and may be used for training machine learning models, in some embodiments. The augmentation engine 214 may augment the inference audio recordings by multiplying it with the channel impulse response.

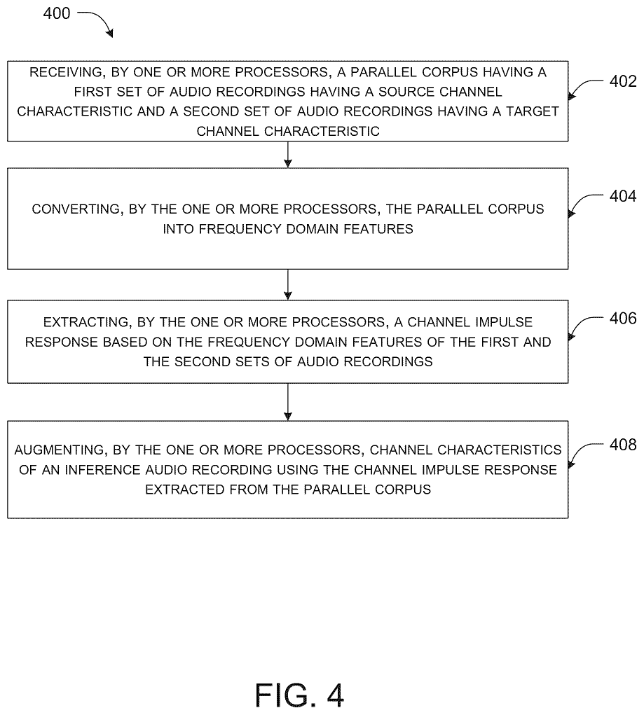

Referring to FIG. 4, a method 400 for augmenting channel characteristics of audio dataset may include a plurality of blocks 402-408.

At block 402, the method 400 may include receiving, by one or more processors such as the processors 202 of FIG. 2, a parallel corpus having a first set of audio recordings having a source channel characteristic and a second set of audio recordings having a target channel characteristic, where the second set of audio recordings is a function of the first set of audio recordings.

At block 404, the method 400 may include converting, by the one or more processors, the parallel corpus into frequency domain features.

At block 406, the method 400 may include extracting, by the one or more processors, a channel impulse response based on the frequency domain features of the first and the second sets of audio recordings.

At block 408, the method 400 may include augmenting, by the one or more processors, an inference audio recording using the channel impulse response extracted from the parallel corpus.

In some embodiments, for extracting the channel impulse response, the method 400 may include determining, by the one or more processors, a cross-correlation value between the frequency domain features of the first and the second sets of the audio recordings, and aligning, by the one or more processors, the first and the second sets of the audio recordings with respect to time domain features thereof based on the cross-correlation value. The method 400 may further include determining, by the one or more processors, the channel impulse response from the frequency domain features of the aligned first and second sets of audio recordings.

In some embodiments, for determining the cross-correlation value, the method 400 may include determining, by the one or more processors, minimum of cross-conjugate values of arguments of maxima of the frequency domain features of the first and the second sets of audio recordings.

In some embodiments, for determining the channel impulse response from the frequency domain features of the aligned first and second sets of audio recordings, the method 400 may include deconvolving, by the one or more processors, the second set of audio recordings using the first set of audio recording to obtain the channel impulse response.

In some embodiments, the channel impulse response may include one or more latent channel characteristics associated with the first and second sets of audio recordings.

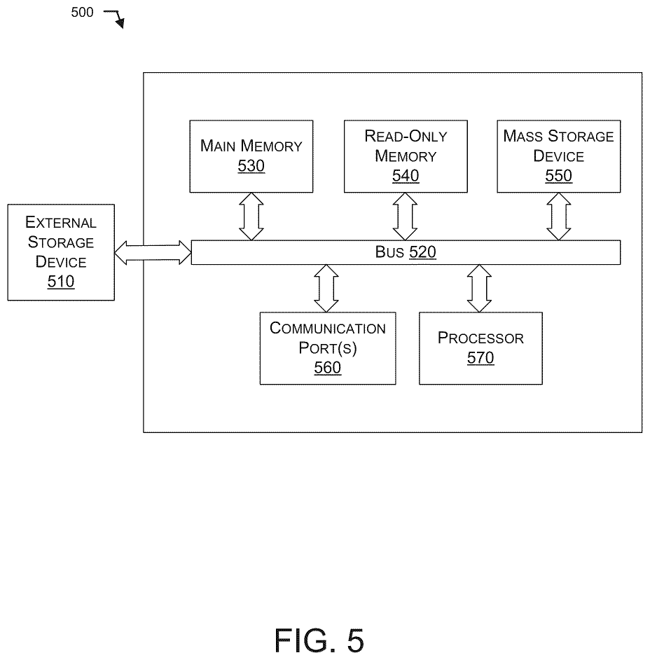

Referring to FIG. 5, the block diagram represents a computer system 500 that includes an external storage device 510, a bus 520, a main memory 530, a read only memory 540, a mass storage device 550, a communication port 560, and a processor 570. A person skilled in the art will appreciate that the computer system 500 may include more than one processor 570 and communication ports 560. The processor 570 may include various modules associated with embodiments of the present disclosure. The communication port 560 can be any of a Recommended Standard 232 port for use with a modem-based dialup connection, a 10/100 Ethernet port, a Gigabit or 10 Gigabit port using copper or fiber, a serial port, a parallel port, or other existing or future ports. The communication port 560 may be chosen depending on a network, such as a Local Area Network (LAN), a Wide Area Network (WAN), or any network to which computer system 500 connects.

In an embodiment, the memory 530 can be a RAM, or any other dynamic storage device commonly known in the art. The Read-Only Memory (ROM) 540 may be any static storage device(s) e.g., but not limited to, a Programmable Read-Only Memory (PROM) chip for storing static information. The mass storage 550 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus 520 communicatively couples the processor(s) 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 570 to the computer system 500.

In another embodiment, operator and administrative interfaces, e.g., a display, keyboard, and a cursor control device, may also be coupled to the bus 520 to support direct operator interaction with computer system 500. Other operator and administrative interfaces may be provided through network connections connected through communication port 560. In some embodiments, the external storage device 510 can be any kind of external hard-drives, floppy drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 500 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### ADVANTAGES OF THE PRESENT DISCLOSURE

The present disclosure provides a system and a method for augmenting channel characteristics of audio datasets.

The present disclosure augments audio datasets having source channel characteristics to any target channel characteristics for training machine learning models therewith.

The present disclosure minimizes time and cost resource required for creating augmented audio datasets.

The present disclosure augments channel characteristics of audio datasets to allow machine learning models trained therewith to process audio recordings independent of language, device of recording, speaker, gender, sampling rate, length of the audio and audio formats.

We claim:

1. A system (110) for augmenting channel characteristics of audio recordings, comprising:
one or more processors (202); and
a memory (204) coupled to the one or more processors (202), wherein the memory (204) comprises processor-executable instructions, which on execution, cause the one or more processors (202) to:
receive a parallel corpus comprising a first set of audio recordings having a source channel characteristic and a second set of audio recordings having a target channel characteristic, wherein the second set of audio recordings is a function of the first set of audio recordings;
convert the parallel corpus into frequency domain features;
extract a channel impulse response based on the frequency domain features of the first and the second sets of audio recordings; and
augment channel characteristics of an inference audio recording using the channel impulse response extracted from the parallel corpus.

2. The system (110) as claimed in claim 1, wherein to extract the channel impulse response, the one or more processors (202) are configured to:
determine a cross-correlation value between the frequency domain features of the first and the second sets of the audio recordings;
align the first and the second sets of the audio recordings with respect to time domain features thereof based on the cross-correlation value; and
determine the channel impulse response from the frequency domain features of the aligned first and second sets of audio recordings.

3. The system (110) as claimed in claim 2, wherein to determine the cross-correlation value the one or more processors (202) are configured to determine the minimum of cross-conjugate values of arguments of maxima of the frequency domain features of the first and the second sets of audio recordings.

4. The system (110) as claimed in claim 2, wherein to determine the channel impulse response from the frequency domain features of the aligned first and second sets of audio recordings the one or more processors (202) are configured to deconvolve the second set of audio recordings using the first set of audio recording to obtain the channel impulse response.

5. The system (110) as claimed in claim 1, wherein the channel impulse response comprises one or more latent channel characteristics associated with the first and second sets of audio recordings.

6. A method (400) for generating synthetic audio recording datasets, comprising:
receiving, by one or more processors (202), a parallel corpus comprising a first set of audio recordings having a source channel characteristic and a second set of audio recordings having a target channel characteristic, wherein the second set of audio recordings is a function of the first set of audio recordings;
converting, by the one or more processors (202), the parallel corpus into frequency domain features;
extracting, by the one or more processors (202), a channel impulse response based on the frequency domain features of the first and the second sets of audio recordings; and
augmenting, by the one or more processors (202), channel characteristics of an inference audio recording using the channel impulse response extracted from the parallel corpus.

7. The method (400) as claimed in claim 6, wherein for extracting the channel impulse response, the method (400) comprises:
determining, by the one or more processors (202), a cross-correlation value between the frequency domain features of the first and the second sets of the audio recordings;
aligning, by the one or more processors (202), the first and the second sets of the audio recordings with respect to time domain features thereof based on the cross-correlation value; and
determining, by the one or more processors (202), the channel impulse response from the frequency domain features of the aligned first and second sets of audio recordings.

8. The method (400) as claimed in claim 7, wherein for determining the cross-correlation value, the method (400) comprises determining, by the one or more processors (202), minimum of cross-conjugate values of arguments of maxima of the frequency domain features of the first and the second sets of audio recordings.

9. The method (400) as claimed in claim 7, wherein for determining the channel impulse response from the frequency domain features of the aligned first and second sets of audio recordings, the method (400) comprises deconvolving, by the one or more processors (202), the second set of audio recordings using the first set of audio recording to obtain the channel impulse response.

10. The method (400) as claimed in claim 6, wherein the channel impulse response comprises one or more latent channel characteristics associated with the first and second sets of audio recordings.
